(19) United States
(12) Patent Application Publication
(10) Pub. No.: US 2024/0335941 A1
(43) Pub. Date: Oct. 10, 2024

(54) ROBOTIC TASK PLANNING

(71) Applicant: Siemens Aktiengesellschaft, Munich (DE)

(72) Inventors: Juan L. Aparicio Ojea, Moraga, CA (US); Heiko Claussen, Wayland, MA (US); Ines Ugalde Diaz, Redwood City, CA (US); Martin Sehr, Kensington, CA (US); Eugen Solowjow, Berkeley, CA (US); Chengtao Wen, Redwood City, CA (US); Wei Xi Xia, Daly City, CA (US); Xiaowen Yu, Union City, CA (US); Shashank Tamaskar, Mohali, Punjab (IN)

(73) Assignee: Siemens Aktiengesellschaft, Munich (DE)

(21) Appl. No.: 18/290,831

(22) PCT Filed: Aug. 31, 2021
(86) PCT No.: PCT/US2021/048530

§ 371 Date: Jan. 22, 2024

(51) Int. Cl. B25J 9/16

(52) U.S. Cl. CPC B25J 9/1661; B25J 9/1664; B25J 9/1697

(57) ABSTRACT

It is recognized herein that current approaches to autonomous operations are often limited to grasping and manipulation operations that can be performed in a single step. It is further recognized herein that there are various operations in robotics (e.g., assembly tasks) that require multiple steps or a sequence of motions to be performed. To determine or plan a sequence of motions for fulfilling a task, an autonomous system that includes a robot can perform object recognition, pose estimation, affordance analysis, decision-making, probabilistic task or motion planning, and object manipulation.

### BACKGROUND

Autonomous operations, such as robotic grasping and manipulation, in unknown or dynamic environments present various technical challenges. Autonomous operations in dynamic environments may be applied to mass customization (e.g., high-mix, low-volume manufacturing), on-demand flexible manufacturing processes in smart factories, warehouse automation in smart stores, automated deliveries from distribution centers in smart logistics, and the like. In order to perform autonomous operations, such as grasping and manipulation, robots may learn skills through exploring the environment. In particular, for example, robots might interact with different objects under different situations. Often, however, such physical interactions in the real world by robots are time consuming, cost prohibitive, and in some cases, dangerous. Three-dimensional (3D) reconstruction of an object or of an environment can create a digital twin or model of a given environment of a robot, or of a robot or portion of a robot, which can enable a robot to learn skills efficiently and safely.

It is recognized herein, however, that current approaches to reconstruction or modeling lack efficiency and capabilities. In particular, current approaches often are limited to grasping and manipulation operations that can be performed in a single step. It is further recognized herein that there are various operations in robotics (e.g., assembly tasks) that require multiple steps or a sequence of motions to be performed.

### BRIEF SUMMARY

Embodiments of the invention address and overcome one or more of the described-herein shortcomings or technical problems by providing methods, systems, and apparatuses for determining a sequence of motions for a robot to perform to fulfill a given task. In accordance with various embodiments, to determine or plan the sequence of motions for fulfilling a task, an autonomous system that includes a robot can perform object recognition, pose estimation, affordance analysis, decision-making, probabilistic task or motion planning, and object manipulation.

In an example aspect, an autonomous system includes an autonomous machine or robot device configured to operate in a physical environment. The autonomous system further includes a processor and a memory storing instructions that, when executed by the processor, cause the autonomous system to perform various operations. In particular, for example, the system can detect an object within the physical environment, and perform pose estimation on the object so as to determine an initial state of the object. The system can identify a task that requires that the autonomous machine interact with the object. Based on the task, the system can determine a final or goal state of the object. Further, the system can determine a plurality of intermediate states associated with the object. The intermediate states can define respective motion sequences for the object to reach the goal state from the initial state. The system can be trained and configured to select one of the motion sequences, so as to define a selected motion sequence. The autonomous machine can be further configured to perform the selected motion sequence, so as to fulfill the task.

In some cases, the system can generate an affordance map associated with the object. Based on the affordance map, the system can determine that the goal state of the object is not reachable without reaching at least one of the plurality of intermediate states. In an example, the system determines that the selected motion sequence defines a path that is shorter than the other motion sequences. In particular, for example, the system can select the given motion sequence by solving a Markov decision problem defined by the initial state, the final state, and the plurality of the intermediate states. In yet another example, the selected motion sequence can define a plurality of state transitions, and the system can execute a first state transition of the plurality of state transitions. Before executing a second state transition of the plurality of state transitions that directly follows the first state transition, the system can determine whether a first intermediate state associated with the first state transition is reached.

### BRIEF DESCRIPTION OF THE SEVERAL VIEWS OF THE DRAWINGS

The foregoing and other aspects of the present invention are best understood from the following detailed description when read in connection with the accompanying drawings. For the purpose of illustrating the invention, there is shown in the drawings embodiments that are presently preferred, it being understood, however, that the invention is not limited to the specific instrumentalities disclosed. Included in the drawings are the following Figures:

FIG. 1 shows an example autonomous machine in an example physical environment that includes various objects, in accordance with an example embodiment.

FIG. 2 illustrates an example neural network that can be trained and configured to generate affordance maps, among other outputs, in accordance with various embodiments.

FIG. 3 is a flow diagram that shows example operations that can be performed according to various embodiments.

FIG. 4 illustrates an example bounding box around a portion of an example object, in accordance with an example embodiment.

FIG. 5 illustrates example states of an example motion sequence that can be processed and performed by the system illustrated in FIG. 2.

FIG. 6 illustrates a computing environment within which embodiments of the disclosure may be implemented.

### DETAILED DESCRIPTION

As an initial matter, it is recognized herein that task-oriented grasping and manipulation for robots can present technical challenges that might differ from, or be addition to, challenges associated with other non-task oriented grasping robotic operations in which the goal is limited to securely grasping an object and/or rotating/translating an object to a desired state. Task-oriented grasping and manipulation operations can focus on the given task, such that the grasping and manipulation strategy is based on the tasks. By way of example, and without limitation, the grasping locations on a knife might be different based on the task. In particular, for example, the robot might need to grasp the knife at its handle for a handover task, and the robot might need to grasp the blade of the knife for a cutting task. Furthermore, the robot may need to manipulate the knife differently depending on the task, so as to fulfill the given task.

It will be understood that above-mentioned described use case is simplified for purposes of example, and task-oriented grasping and manipulations can vary in terms of complexity and use cases, among other things, and all such task-oriented grasping and manipulations are contemplated as being within the scope of this disclosure. For example, multi-step grasping and manipulation operations may be performed in fulfilling assembly tasks, among others. By way of example, when a robot performs a Lego assembly, some tasks might involve placing small pieces into desired locations. To do so, a given piece and a gripper of the robot may need to be in a desired state or orientation. In particular, for example, a given piece may need to face in the direction (e.g., up) from which the robot grasps the piece and picks the piece up, so that the piece can be inserted between two other pieces. Continuing with the example, if the piece faces the opposite direction (e.g., down) in its original state, then the robot cannot grasp the piece in a single step and achieve the assembly goal. Rather, the robot may be required to perform a sequence of motions to ultimately fulfill the task. In various examples, the required skills performed by the robot may include, without limitation: object recognition and pose estimation, affordance analysis, decision making, probabilistic task planning/motion planning, and object manipulation.

Thus, it is recognized herein that current approaches to autonomous operations are often limited to grasping and manipulation operations with an assumption of known feasible tasks (e.g., a robot picks up a mug from a table). It is further recognized herein that there are various operations in robotics (e.g., assembly tasks) that feasible operations/motion planning are not known prior to performing the tasks. (e.g., a robot picks up a coffee mug in a sealed box on a table). This task requires multiple steps or a sequence of motions to be performed, and some intermediate tasks/steps must be generated on the fly (e.g., robot unsealing the box is a novel intermediate task). To determine or plan a sequence of motions for fulfilling a task, an autonomous system that includes a robot can perform object recognition, pose estimation, affordance analysis, decision-making, probabilistic task or motion planning, and object manipulation. As described herein, a task planner module can automatically generate new intermediate operation steps to convert an initially unfeasible task into a feasible task via task-relevant affordance analysis and deep reinforcement learning.

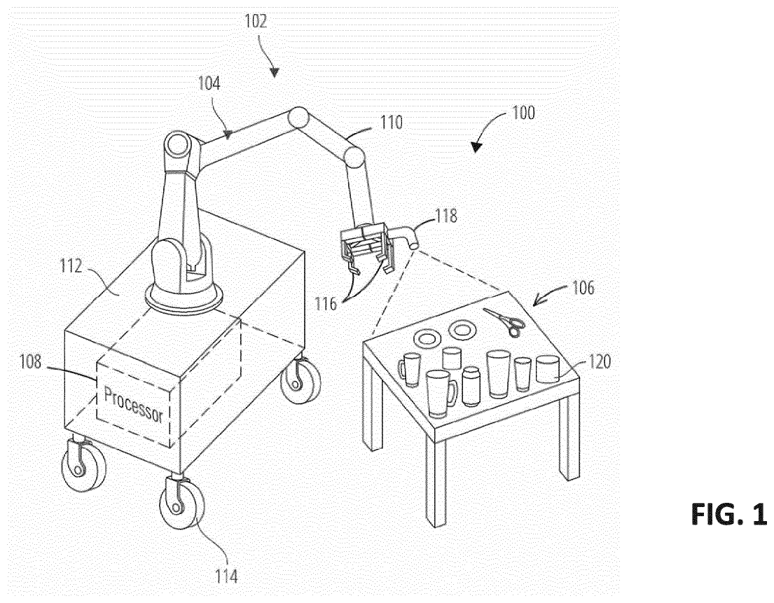

Referring now to FIG. 1, an example industrial or physical environment 100 is shown. As used herein, a physical environment can refer to any unknown or dynamic industrial environment. A reconstruction or model may define a virtual representation of the physical environment 100 or one or more objects 106 within the physical environment 100. The physical environment 100 can include a computerized autonomous system 102 configured to perform one or more manufacturing operations, such as assembly, transport, or the like. The autonomous system 102 can include one or more robot devices or autonomous machines, for instance an autonomous machine or robot device 104, configured to perform one or more industrial tasks, such as bin picking, grasping, or the like. The system 102 can include one or more computing processors configured to process information and control operations of the system 102, in particular the autonomous machine 104. The autonomous machine 104 can include one or more processors, for instance a processor 108, configured to process information and/or control various operations associated with the autonomous machine 104. An autonomous system for operating an autonomous machine within a physical environment can further include a memory for storing modules. The processors can further be configured to execute the modules so as to process information and generate models based on the information. It will be understood that the illustrated environment 100 and the system 102 are simplified for purposes of example. The environment 100 and the system 102 may vary as desired, and all such systems and environments are contemplated as being within the scope of this disclosure.

Still referring to FIG. 1, the autonomous machine 104 can further include a robotic arm or manipulator 110 and a base 112 configured to support the robotic manipulator 110. The base 112 can include wheels 114 or can otherwise be configured to move within the physical environment 100. The autonomous machine 104 can further include an end effector 116 attached to the robotic manipulator 110. The end effector 116 can include one or more tools configured to grasp and/or move objects 106. Example end effectors 116 include finger grippers or vacuum-based grippers. The robotic manipulator 110 can be configured to move so as to change the position of the end effector 116, for example, so as to place or move objects 106 within the physical environment 100. The system 102 can further include one or more cameras or sensors, for instance a three-dimensional (3D) point cloud camera 118, configured to detect or record objects 106 within the physical environment 100. The camera 118 can be mounted to the robotic manipulator 110 or otherwise configured to generate a 3D point cloud of a given scene, for instance the physical environment 100. Alternatively, or additionally, the one or more cameras of the system 102 can include one or more standard two-dimensional (2D) cameras that can record or capture images (e.g., RGB images or depth images) from different viewpoints. Those images can be used to construct 3D images. For example, a 2D camera can be mounted to the robotic manipulator 110 so as to capture images from perspectives along a given trajectory defined by the manipulator 110.

With continuing reference to FIG. 1, in an example, one or more cameras can be positioned over the autonomous machine 104, or can otherwise be disposed so as to continuously monitor any objects within the environment 100. For example, when an object, for instance one of the objects 106, is disposed or moved within the environment 100, the camera 118 can detect the object. In an example, the processor 108 can determine whether a given object that is detected is recognized by the autonomous system 102, so as to determine whether an object is classified as known or unknown (new). In some examples, a deep neural network is trained on a set of objects. Based on its training, the deep neural network can calculate grasp scores for respective regions of a given new object when the object is detected within the environment 100. In an example, when the grasp score is larger than a predefined threshold, the region associated with the graph score is classified as an area in which the end effector 116, for instance a vacuum-based gripper, can grasp. Conversely, in an example, when the grasp score is lower than the predefined threshold, region associated with the graph score is classified as an area (e.g., edge, negative space) other than an area in which the end effector 116, for instance a vacuum-based gripper, can grasp.

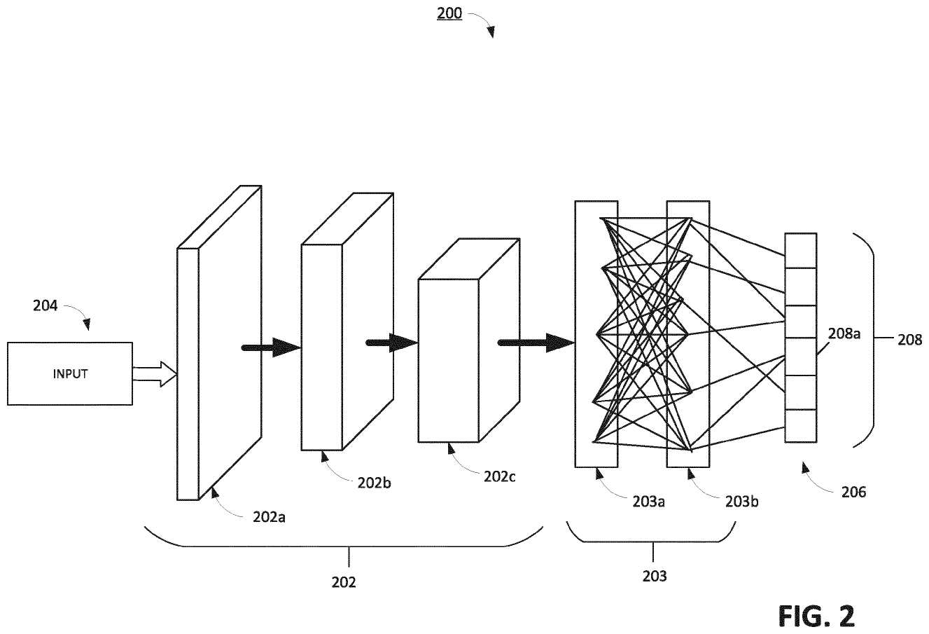

As described herein, the robot device 104 and/or the system 102 can define one or more neural networks configured to learn various objects so as to identify poses, grasp points (or locations), and/or or affordances of various objects that can be found within various industrial environments. Referring now to FIG. 2, an example system or neural network model 200 can be configured to learn objects and grasp locations, based on images for example, in accordance with various example embodiments. After the neural network 200 is trained, for example, images of objects can be sent to the neural network 200 by the robot device 104 for classification, in particular classification of grasp locations or affordances.

The example neural network 200 includes a plurality of layers, for instance an input layer 202a configured to receive an image, an output layer 203b configured to generate class or output scores associated with the image or portions of the image. For example, the output layer 203b can be configured to label each pixel of an input image with a grasp affordance metric. In some cases, the grasp affordance metric or grasp score indicates a probability that the associated grasp will be successful. Success generally refers to an object being grasped and carried without the object dropping. The neural network 200 further includes a plurality of intermediate layers connected between the input layer 202a and the output layer 203b. In particular, in some cases, the intermediate layers and the input layer 202a can define a plurality of convolutional layers 202. The intermediate layers can further include one or more fully connected layers 203. The convolutional layers 202 can include the input layer 202a configured to receive training and test data, such as images. In some cases, training data that the input layer 202a receives includes synthetic data of arbitrary objects. Synthetic data can refer to training data that has been created in simulation so as to resemble actual camera images. The convolutional layers 202 can further include a final convolutional or last feature layer 202c, and one or more intermediate or second convolutional layers 202b disposed between the input layer 202a and the final convolutional layer 202c. It will be understood that the illustrated model 200 is simplified for purposes of example. In particular, for example, models may include any number of layers as desired, in particular any number of intermediate layers, and all such models are contemplated as being within the scope of this disclosure.

The fully connected layers 203, which can include a first layer 203a and a second or output layer 203b, include connections between layers that are fully connected. For example, a neuron in the first layer 203a may communicate its output to every neuron in the second layer 203b, such that each neuron in the second layer 203b will receive input from every neuron in the first layer 203a. It will again be understood that the model is simplified for purposes of explanation, and that the model 200 is not limited to the number of illustrated fully connected layers 203. In contrast to the fully connected layers, the convolutional layers 202 may be locally connected, such that, for example, the neurons in the intermediate layer 202b might be connected to a limited number of neurons in the final convolutional layer 202c. The convolutional layers 202 can also be configured to share connections strengths associated with the strength of each neuron.

Still referring to FIG. 2, the input layer 202a can be configured to receive inputs 204, for instance an image 204, and the output layer 203b can be configured to return an output 206. In some cases, the input 204 can define a depth frame image of an object captured by one or more cameras pointed toward the object, such as the cameras of the system 102. The output 206 can include one or more classifications or scores associated with the input 204. For example, the output 206 can include an output vector that indicates a plurality of scores 208 associated with various portions, for instance pixels, of the corresponding input 204. By way of example, the input 204 can define a depth image of an object 120, for instance an object 120, in particular a coffee mug 120. Based on the image of the mug 120, for example, the output 206 can include various scores 208 associated with pixels of the input image 204, and thus regions of the mug 120. For example, grasp scores can be associated with respective regions of the mug 120 300. Grasp scores can indicate the best locations for grasping an object based on the particular end effector 116.

Thus, the output layer 203b can be configured to generate grasp scores 208 associated with the image 204, in particular associated with pixels of the image 204, thereby generating grasp scores associated with locations of the object depicted in the image 204. The scores 208 can include a target score 208a associated with an optimal grasp location of the image 204 for a given end effector 116. As described herein, the output layer 203b can be configured to generate grasp scores or affordances 208 associated with various regions of various objects used in industrial settings, such as doors, handles, user interfaces, displays, workpieces, holes, plugs, or the like.

The input 204 is also referred to as the image 204 for purposes of example, but embodiments are not so limited. The input 204 can be an industrial image, for instance an image that includes a part that is classified so as to identify a grasp region for an assembly. It will be understood that the model 200 can provide visual recognition and classification of various objects and/or images captured by various sensors or cameras, and all such objects and images are contemplated as being within the scope of this disclosure.

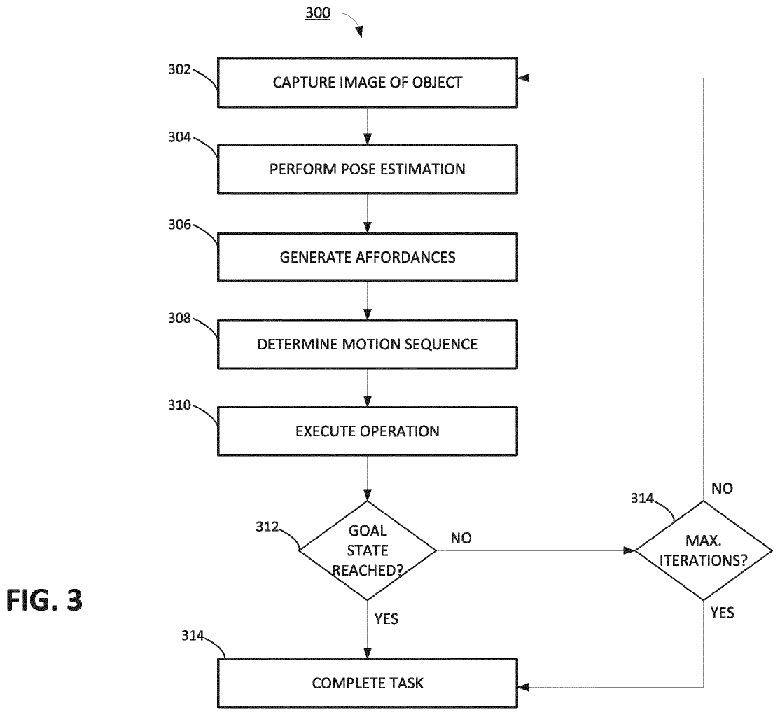

Referring now to FIG. 3, the autonomous system 102 can perform example operations 300 in accordance with various embodiments. At 302, one or more images of an object, for instance one of the objects 106, can be captured, for instance by the camera 118. In some examples, a 3D reconstruction of the object can be generated, which generally refers to fusing multiple views (e.g., camera views) of a spatially bounded object together so as to construct a 3D geometric model of the object. Example views that can be used in 3D reconstruction include RGB images, depth images, RGB-D images, or the like. In some cases, at 304, the pose (e.g., position and orientation) of the object can be estimated based on the reconstruction of the object, which can be based on images of the object.

Alternatively, or additionally, the autonomous system 102 can capture an RGB image of a given object, and recognize or identify the object based on the image. Thereafter, at 304, the autonomous system can estimate the pose of the object based on the captured image, for instance an RGB image. In particular, for example, the image can be input into a pose CNN or other neural network, for instance the neural network 200 that can be configured to estimate poses, so as to define the input 204. In an example, the pose CNN can estimate the 3D translation of an object by localizing the center of the object in the corresponding image, and predicting the distance of the center from the camera that captured the corresponding image. The 3D rotation of the object can then be estimated, at 304, by regressing to a quaternion representation. It is recognized herein that the pose CNN can be highly robust to occlusions, and can provide accurate pose estimations using, in some cases, only color images as input. In accordance with various examples, pose estimation can be performed on symmetrical objects and asymmetrical objects.

After the pose of the object is estimated, the autonomous system can perform task planning. The task associated with the object can be received (e.g., via a user interface) or otherwise obtained (e.g., via memory) by the autonomous system 102, for instance when an image of the object is captured. In some cases, the task may indicate a final or goal position of the object within the environment. By way of example, a task might relate to an assembly of a system or blister pack, such that the goal position of the object (e.g., part or product) corresponds to its final position within the system or blister pack. Referring to FIG. 3, at 306, based on the task and the pose estimation of the object, the autonomous system 102 can perform an affordance analysis on the object, which can result in an affordance map of the object. Thus, the autonomous system 102 can generate affordances associated with the object, at 306.

Affordances or affordance maps define properties of objects that indicate actions that can be taken involving a respective object. For example, an affordance can define the relationship between the robot or autonomous machine 104 and its environment 100. Thus, an affordance can define a relationship between the properties of an object, for instance the object or mug 120 of the objects 106, and the capabilities of an agent, for instance the autonomous machine 104. Such a relationship can indicate the various ways that the object can be used by the agent. In some cases, affordances related to components or parts of an object, such that the affordances describe functional (e.g., structure, material) semantic properties and topological relationships between components or parts. From such component or part affordances, a generic, scalable, and cognitive architecture can be built for object class recognition and visual perception systems.

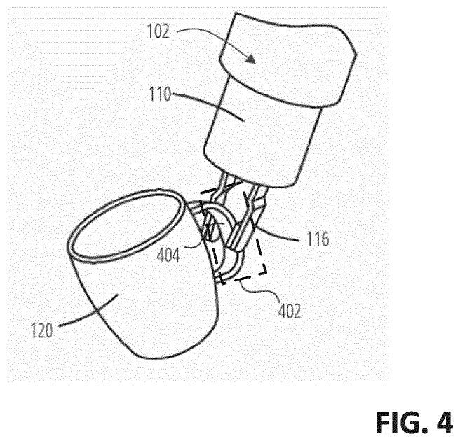

Referring again to FIG. 3, the output of the pose CNN can include a pose estimation for a given object, which can be input into an affordance network along with one or more images of the object (at 306). The affordance network can define a deep neural network model, for instance the neural network 200, trained and configured to detect affordances associated with an object from RGB-depth (RGB-D) images. In particular, for example, the affordance network can include one or more deep Convolutional Neural Networks (CNN), for instance an object detector neural network and an affordance neural network that defines conditional random fields (CRFs), configured to detect object affordances in real-world scenes. In some cases, the autonomous system 102 can train its object detector neural network to generate bounding box candidates from images. Referring also to FIG. 4, a bounding box 402 may be generated that surrounds a handle 404 of the mug 120. More generally, the deep network, for instance the neural network 200, that is configured as an object detector can generate bounding boxes associated with the objects that are grasped or manipulated. The affordance network can then use the bounding boxes associated with the objects to learn the depth features associated with the portions of the object withing the respective bounding box. Thus, the affordance network can generate feature or affordance maps, which can be post-processed with a dense CRF so as to improve the prediction along class boundaries. Thus, based on the task inputs and the affordance map of an object, a desired interaction area of the object can be determined. This desired interaction area, for instance the handle 404 of the mug 120, can define an input to task planner module of the autonomous system 102.

Referring again to FIG. 3, at 308, the task planner module can determine a motion sequence of a robot, for instance the autonomous machine 104, for performing the task with the object. In some cases, the task planner module solves a Markov decision process (MDP) that defines a discrete time stochastic control process. Thus, the task planner module can provide a mathematical framework for modeling decision-making in situations where outcomes are partly random and partly under the control of a decision maker. In particular, the task planner module can learn optimization problems solved via dynamic programming and reinforcement learning. For example, at a given time step, the process or autonomous machine 104 is in a given state, and the decision maker may choose any action that is available from the given state. The process responds at the next time step by randomly moving into a new state, and giving the decision maker a corresponding reward.

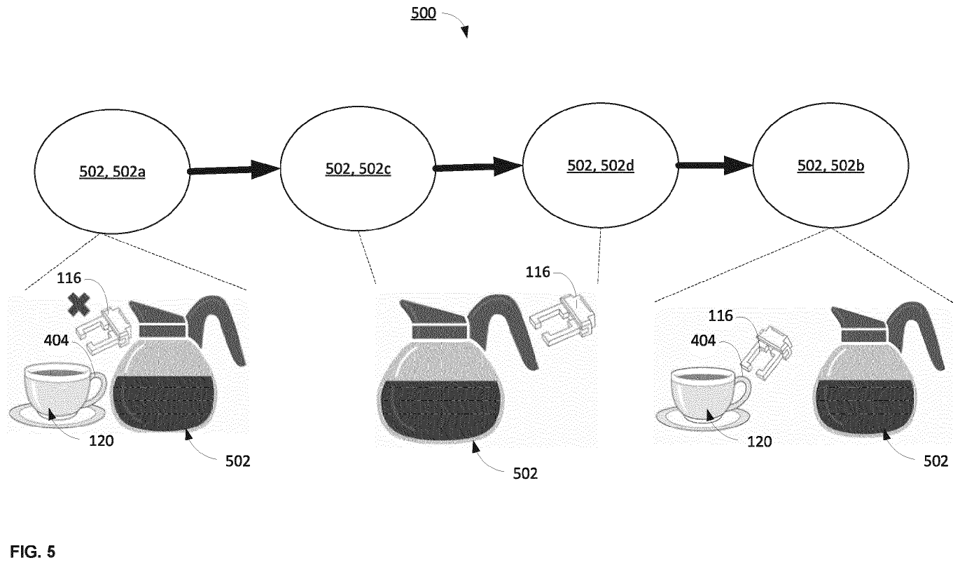

Referring also to FIG. 5, example discretized states 502 of an example environment 500 are shown. In the example, the environment 500 includes the autonomous machine 104 and objects 106, in particular the mug 120 and a coffee pot 504. It will be understood that the environment 500 and the states 502 are simplified for purposes for example, such that the environment and states can vary in terms of complexity, and all such environments having any number of states are contemplated as being within the scope of this disclosure. The states 502 that are processed by the task planner module of the autonomous system 102 can relate to physical states of the autonomous machine 104 or any of the objects 106 within the environment 500, in particular the mug 120 and coffee pot 502.

By way of example, referring also to FIG. 3, at 302, pose estimation can be performed on the objects within the environment 500, in particular the mug 120 and the coffee pot 504. As a result of the pose estimation, a first or initial state 502a can be identified. In accordance with the illustrated example, the initial state 502a can indicate that the mug 120 and the pot 502 are placed adjacent to each other. Thus, the initial state 502a can define a pose of the object. At 504, affordance analysis can be performed that can detect grasping properties of the objects. For example, the system 102 can perform affordance analysis to determine whether the mug 120 can be grasped by the autonomous machine. In particular, for example, the system 102 might determine that the handle 404 cannot be grasped by the autonomous machine 104 because it is too close to the pot 504. At 304, based on the input task, the task planner module can determine a goal or final state 502b. In some cases, the pose estimation can be performed to determine a pose associated with the goal state. In accordance with the illustrated example, the goal state 502b can indicate the handle 404 of the mug 120 is grasped by the autonomous machine 104, in particular the end effector 116. Further, based on the goal state 502b and the initial state 502a, the task planner module can generate one or more intermediate states, for instance a first intermediate state 502c and a second intermediate state 502d, between the initial state 502a and the goal state 502b. The intermediate states can enable the system 102 to reach the goal state from the initial state. In accordance with the illustrated example, the intermediate states 502c-d can enable the autonomous machine 104 to grasp the mug 120, in particular the handle 404 of the mug 120. In particular, with continuing reference to FIG. 5, the first intermediate state 502c can indicate that the pot 504 is grasped by the autonomous machine 104, and the second intermediate state 502d can indicate that the pot 504 is moved away from mug 120.

At 308, the task planner can employ MDP so as to determine the motion sequence of the autonomous machine 104. For example, with respect to different types of grasping on a different locations of an object, there can be different probabilities that the object will be dropped. Thus, the likelihood of successful motion can be modeled or learned via stochastic learning by the autonomous system 102, in particular the task planner module. Referring again to FIG. 5, using MDP, the task planner can determine the shortest feasible (e.g., likelihood of successful motion greater than a threshold) path between the initial state 502a and the goal state 502b. In some cases, the task planner module can generate multiple feasible paths or solutions from the initial state 502a to the goal state 502b. The multiple feasible paths can be illustrated as a graph with multiple nodes, wherein the nodes represent states, and lines connecting the nodes represent actions or state transitions, such as feasible actions 506. Thus, the task planner module can generate a plan for a given task, which can define multiple intermediate states and feasible actions. The multiple feasible states and multiple feasible actions can define multiple feasible paths for performing the goal state from the initial state. The task planner can further select on of the feasible paths, for instance the shortest feasible path, so as to define a planned trajectory.

Referring again to FIG. 3, after the planned trajectory is generated, the autonomous machine 104 can execute an operation or step of the planned trajectory or motion sequence (at 310), so as to minimize uncertainty of the system 102. For example, referring to FIG. 5, the robot 104 may execute a first feasible action 506a that can dispose the environment in the first intermediate state 502c from the initial state 502a. At 312, the autonomous system 102, in particular the task planner module, can determine whether the goal state 502b is reached. If the goal state is reached, the process can proceed to 314, where the task is completed or fulfilled. If the goal state is not reached, the task planner module can determine whether a maximum number of iterations has been reached, at 316. If the maximum number of iterations has been reached, the task planner module can end the performance of the task. If the maximum number of iterations has not been reached, the path planner module can attempt to find a new feasible path during a new iteration. Thus, the process can return to 302. The maximum number of iterations can define a predetermined number for planning or re-planning the sequence of actions for completing the given task.

Thus, as described herein in accordance with various embodiments, an autonomous system can include an autonomous machine or robot device configured to operate in a physical environment. The autonomous system can further include a processor and a memory storing instructions that, when executed by the processor, cause the autonomous system to perform various operations. In particular, for example, the system can detect an object within the physical environment, and perform pose estimation on the object so as to determine an initial state of the object. The pose estimation can also be performed to determine a pose associated with the goal state of the object. The system can identify a task that requires that the autonomous machine interact with the object. Based on the task, the system can determine a final or goal state of the object. Further, the system can determine a plurality of intermediate states associated with the object. In some cases, the intermediate states are determined based on the initial state, the pose associated with the goal state, and the task. In an example, an affordance analysis is performed on the object so as to determine a plurality of feasible actions for the autonomous machine in completing the task.

The intermediate states can define respective motion sequences for the object to reach the goal state from the initial state. The system can be trained and configured to select one of the motion sequences, so as to define a selected motion sequence. The autonomous machine can be further configured to perform the selected motion sequence, so as to fulfill the task.

In some cases, the system can generate an affordance map associated with the object. Based on the affordance map, the system can determine that the goal state of the object is not reachable without reaching at least one of the plurality of intermediate states. Alternatively, or additionally, based on the affordance map and task, the system can generate at least one intermediate state of the plurality of intermediate states, wherein the at least one additional intermediate state enables the goal state to be reachable. Further, the system can augment the affordance map with the at least one additional intermediate state.

In an example, the system determines that the selected motion sequence defines a path that is shorter than the other motion sequences. In particular, for example, the system can select the given motion sequence by solving a Markov decision problem defined by the initial state, the final state, and the plurality of the intermediate states. In yet another example, the selected motion sequence can define a plurality of state transitions, and the system can execute a first state transition of the plurality of state transitions. Before executing a second state transition of the plurality of state transitions that directly follows the first state transition, the system can determine whether a first intermediate state associated with the first state transition is reached.

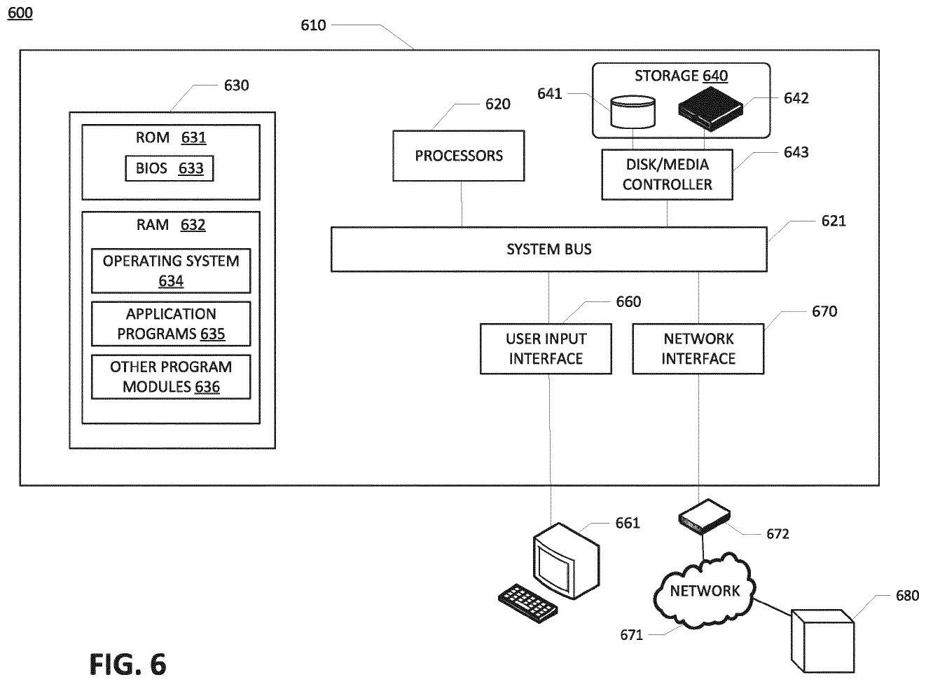

FIG. 6 illustrates an example of a computing environment within which embodiments of the present disclosure may be implemented. A computing environment 600 includes a computer system 610 that may include a communication mechanism such as a system bus 621 or other communication mechanism for communicating information within the computer system 610. The computer system 610 further includes one or more processors 620 coupled with the system bus 621 for processing the information. The autonomous system 102 may include, or be coupled to, the one or more processors 620.

The processors 620 may include one or more central processing units (CPUs), graphical processing units (GPUs), or any other processor known in the art. More generally, a processor as described herein is a device for executing machine-readable instructions stored on a computer readable medium, for performing tasks and may comprise any one or combination of, hardware and firmware. A processor may also comprise memory storing machine-readable instructions executable for performing tasks. A processor acts upon information by manipulating, analyzing, modifying, converting or transmitting information for use by an executable procedure or an information device, and/or by routing the information to an output device. A processor may use or comprise the capabilities of a computer, controller or microprocessor, for example, and be conditioned using executable instructions to perform special purpose functions not performed by a general purpose computer. A processor may include any type of suitable processing unit including, but not limited to, a central processing unit, a microprocessor, a Reduced Instruction Set Computer (RISC) microprocessor, a Complex Instruction Set Computer (CISC) microprocessor, a microcontroller, an Application Specific Integrated Circuit (ASIC), a Field-Programmable Gate Array (FPGA), a System-on-a-Chip (SoC), a digital signal processor (DSP), and so forth. Further, the processor(s) 620 may have any suitable microarchitecture design that includes any number of constituent components such as, for example, registers, multiplexers, arithmetic logic units, cache controllers for controlling read/write operations to cache memory, branch predictors, or the like. The microarchitecture design of the processor may be capable of supporting any of a variety of instruction sets. A processor may be coupled (electrically and/or as comprising executable components) with any other processor enabling interaction and/or communication there-between. A user interface processor or generator is a known element comprising electronic circuitry or software or a combination of both for generating display images or portions thereof. A user interface comprises one or more display images enabling user interaction with a processor or other device.

The system bus 621 may include at least one of a system bus, a memory bus, an address bus, or a message bus, and may permit exchange of information (e.g., data (including computer-executable code), signaling, etc.) between various components of the computer system 610. The system bus 621 may include, without limitation, a memory bus or a memory controller, a peripheral bus, an accelerated graphics port, and so forth. The system bus 621 may be associated with any suitable bus architecture including, without limitation, an Industry Standard Architecture (ISA), a Micro Channel Architecture (MCA), an Enhanced ISA (EISA), a Video Electronics Standards Association (VESA) architecture, an Accelerated Graphics Port (AGP) architecture, a Peripheral Component Interconnects (PCI) architecture, a PCI-Express architecture, a Personal Computer Memory Card International Association (PCMCIA) architecture, a Universal Serial Bus (USB) architecture, and so forth.

Continuing with reference to FIG. 6, the computer system 610 may also include a system memory 630 coupled to the system bus 621 for storing information and instructions to be executed by processors 620. The system memory 630 may include computer readable storage media in the form of volatile and/or nonvolatile memory, such as read only memory (ROM) 631 and/or random access memory (RAM) 632. The RAM 632 may include other dynamic storage device(s) (e.g., dynamic RAM, static RAM, and synchronous DRAM). The ROM 631 may include other static storage device(s) (e.g., programmable ROM, erasable PROM, and electrically erasable PROM). In addition, the system memory 630 may be used for storing temporary variables or other intermediate information during the execution of instructions by the processors 620. A basic input/output system 633 (BIOS) containing the basic routines that help to transfer information between elements within computer system 610, such as during start-up, may be stored in the ROM 631. RAM 632 may contain data and/or program modules that are immediately accessible to and/or presently being operated on by the processors 620. System memory 630 may additionally include, for example, operating system 634, application programs 635, and other program modules 636. Application programs 635 may also include a user portal for development of the application program, allowing input parameters to be entered and modified as necessary.

The operating system 634 may be loaded into the memory 630 and may provide an interface between other application software executing on the computer system 610 and hardware resources of the computer system 610. More specifically, the operating system 634 may include a set of computer-executable instructions for managing hardware resources of the computer system 610 and for providing common services to other application programs (e.g., managing memory allocation among various application programs). In certain example embodiments, the operating system 634 may control execution of one or more of the program modules depicted as being stored in the data storage 640. The operating system 634 may include any operating system now known or which may be developed in the future including, but not limited to, any server operating system, any mainframe operating system, or any other proprietary or non-proprietary operating system.

The computer system 610 may also include a disk/media controller 643 coupled to the system bus 621 to control one or more storage devices for storing information and instructions, such as a magnetic hard disk 641 and/or a removable media drive 642 (e.g., floppy disk drive, compact disc drive, tape drive, flash drive, and/or solid state drive). Storage devices 640 may be added to the computer system 610 using an appropriate device interface (e.g., a small computer system interface (SCSI), integrated device electronics (IDE), Universal Serial Bus (USB), or FireWire). Storage devices 641, 642 may be external to the computer system 610.

The computer system 610 may also include a field device interface 665 coupled to the system bus 621 to control a field device 666, such as a device used in a production line. The computer system 610 may include a user input interface or GUI 661, which may comprise one or more input devices, such as a keyboard, touchscreen, tablet and/or a pointing device, for interacting with a computer user and providing information to the processors 620.

The computer system 610 may perform a portion or all of the processing steps of embodiments of the invention in response to the processors 620 executing one or more sequences of one or more instructions contained in a memory, such as the system memory 630. Such instructions may be read into the system memory 630 from another computer readable medium of storage 640, such as the magnetic hard disk 641 or the removable media drive 642. The magnetic hard disk 641 (or solid state drive) and/or removable media drive 642 may contain one or more data stores and data files used by embodiments of the present disclosure. The data store 640 may include, but are not limited to, databases (e.g., relational, object-oriented, etc.), file systems, flat files, distributed data stores in which data is stored on more than one node of a computer network, peer-to-peer network data stores, or the like. The data stores may store various types of data such as, for example, skill data, sensor data, or any other data generated in accordance with the embodiments of the disclosure. Data store contents and data files may be encrypted to improve security. The processors 620 may also be employed in a multi-processing arrangement to execute the one or more sequences of instructions contained in system memory 630. In alternative embodiments, hard-wired circuitry may be used in place of or in combination with software instructions. Thus, embodiments are not limited to any specific combination of hardware circuitry and software.

As stated above, the computer system 610 may include at least one computer readable medium or memory for holding instructions programmed according to embodiments of the invention and for containing data structures, tables, records, or other data described herein. The term “computer readable medium” as used herein refers to any medium that participates in providing instructions to the processors 620 for execution. A computer readable medium may take many forms including, but not limited to, non-transitory, non-volatile media, volatile media, and transmission media. Non-limiting examples of non-volatile media include optical disks, solid state drives, magnetic disks, and magneto-optical disks, such as magnetic hard disk 641 or removable media drive 642. Non-limiting examples of volatile media include dynamic memory, such as system memory 630. Non-limiting examples of transmission media include coaxial cables, copper wire, and fiber optics, including the wires that make up the system bus 621. Transmission media may also take the form of acoustic or light waves, such as those generated during radio wave and infrared data communications.

Computer readable medium instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, may be implemented by computer readable medium instructions.

The computing environment 600 may further include the computer system 610 operating in a networked environment using logical connections to one or more remote computers, such as remote computing device 680. The network interface 670 may enable communication, for example, with other remote devices 680 or systems and/or the storage devices 641, 642 via the network 671. Remote computing device 680 may be a personal computer (laptop or desktop), a mobile device, a server, a router, a network PC, a peer device or other common network node, and typically includes many or all of the elements described above relative to computer system 610. When used in a networking environment, computer system 610 may include modem 672 for establishing communications over a network 671, such as the Internet. Modem 672 may be connected to system bus 621 via user network interface 670, or via another appropriate mechanism.

Network 671 may be any network or system generally known in the art, including the Internet, an intranet, a local area network (LAN), a wide area network (WAN), a metropolitan area network (MAN), a direct connection or series of connections, a cellular telephone network, or any other network or medium capable of facilitating communication between computer system 610 and other computers (e.g., remote computing device 680). The network 671 may be wired, wireless or a combination thereof. Wired connections may be implemented using Ethernet, Universal Serial Bus (USB), RJ-6, or any other wired connection generally known in the art. Wireless connections may be implemented using Wi-Fi, WiMAX, and Bluetooth, infrared, cellular networks, satellite or any other wireless connection methodology generally known in the art. Additionally, several networks may work alone or in communication with each other to facilitate communication in the network 671.

It should be appreciated that the program modules, applications, computer-executable instructions, code, or the like depicted in FIG. 6 as being stored in the system memory 630 are merely illustrative and not exhaustive and that processing described as being supported by any particular module may alternatively be distributed across multiple modules or performed by a different module. In addition, various program module(s), script(s), plug-in(s), Application Programming Interface(s) (API(s)), or any other suitable computer-executable code hosted locally on the computer system 610, the remote device 680, and/or hosted on other computing device(s) accessible via one or more of the network(s) 671, may be provided to support functionality provided by the program modules, applications, or computer-executable code depicted in FIG. 6 and/or additional or alternate functionality. Further, functionality may be modularized differently such that processing described as being supported collectively by the collection of program modules depicted in FIG. 6 may be performed by a fewer or greater number of modules, or functionality described as being supported by any particular module may be supported, at least in part, by another module. In addition, program modules that support the functionality described herein may form part of one or more applications executable across any number of systems or devices in accordance with any suitable computing model such as, for example, a client-server model, a peer-to-peer model, and so forth. In addition, any of the functionality described as being supported by any of the program modules depicted in FIG. 6 may be implemented, at least partially, in hardware and/or firmware across any number of devices.

It should further be appreciated that the computer system 610 may include alternate and/or additional hardware, software, or firmware components beyond those described or depicted without departing from the scope of the disclosure. More particularly, it should be appreciated that software, firmware, or hardware components depicted as forming part of the computer system 610 are merely illustrative and that some components may not be present or additional components may be provided in various embodiments. While various illustrative program modules have been depicted and described as software modules stored in system memory 630, it should be appreciated that functionality described as being supported by the program modules may be enabled by any combination of hardware, software, and/or firmware. It should further be appreciated that each of the above-mentioned modules may, in various embodiments, represent a logical partitioning of supported functionality. This logical partitioning is depicted for ease of explanation of the functionality and may not be representative of the structure of software, hardware, and/or firmware for implementing the functionality. Accordingly, it should be appreciated that functionality described as being provided by a particular module may, in various embodiments, be provided at least in part by one or more other modules. Further, one or more depicted modules may not be present in certain embodiments, while in other embodiments, additional modules not depicted may be present and may support at least a portion of the described functionality and/or additional functionality. Moreover, while certain modules may be depicted and described as sub-modules of another module, in certain embodiments, such modules may be provided as independent modules or as sub-modules of other modules.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure. In addition, it should be appreciated that any operation, element, component, data, or the like described herein as being based on another operation, element, component, data, or the like can be additionally based on one or more other operations, elements, components, data, or the like. Accordingly, the phrase “based on,” or variants thereof, should be interpreted as “based at least in part on.”

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method for operating an autonomous machine in a physical environment, the method comprising:
detecting an object within the physical environment;
performing pose estimation on the object so as to determine an initial state of the object;
identifying a task that requires that the autonomous machine interact with the object;
based on the task, determining a goal state of the object;
determining a plurality of intermediate states associated with the object, the intermediate states defining respective motion sequences for the object to reach the goal state from the initial state;
selecting one of the motion sequences, so as to define a selected motion sequence; and
the autonomous machine performing the selected motion sequence, thereby fulfilling the task.

2. The method as recited in claim 1, the method further comprising:
performing the pose estimation so as to determine a pose associated with the goal state of the object.

3. The method as recited in claim 2, the method further comprising:
determining the plurality of intermediate states based on the initial state, the pose associated with the goal state, and the task.

4. The method as recited in claim 3, wherein determining the plurality of intermediate steps further comprises:
performing an affordance analysis on the object so as to determine a plurality of feasible actions for the autonomous machine in completing the task.

5. The method as recited in claim 1, wherein determining the plurality of intermediate states further comprises:
generating an affordance map associated with the object,
based on the affordance map, determining that the goal state of the object is not reachable without reaching at least one of the plurality of intermediate states.

6. The method as recited in claim 5, the method further comprising:
based on the affordance map and task, generating at least one intermediate state of the plurality of intermediate states, the at least one additional intermediate state enabling the goal state to be reachable; and
augmenting the affordance map with the at least one additional intermediate state.

7. The method as recited in a claim 1, wherein selecting one of the motion sequences comprises:
determining that the selected motion sequence defines a path that is shorter than the other motion sequences.

8. The method as recited in claim 5, wherein selecting one of the motion sequences further comprises:
solving a Markov decision problem defined by the initial state, the goal state, and the plurality of the intermediate states.

9. The method as recited in claim 1, wherein the selected motion sequence defines a plurality of state transitions, and performing the selected motion sequence further comprises:
executing a first state transition of the plurality of state transitions; and
before executing a second state transition of the plurality of state transitions that directly follows the first state transition, determining whether a first intermediate state associated with the first state transition is reached.

10. An autonomous system, the autonomous system comprising:
an autonomous machine configured to operate in a physical environment;
a processor; and
a memory storing instructions that, when executed by the processor, cause the autonomous system to:
detecting an object within the physical environment;
perform pose estimation on the object so as to determine an initial state of the object;
identify a task that requires that the autonomous machine interact with the object;
based on the task, determining a goal state of the object;
determining a plurality of intermediate states associated with the object, the intermediate states defining respective motion sequences for the object to reach the goal state from the initial state; and
select one of the motion sequences, so as to define a selected motion sequence,
wherein the autonomous machine is further configured to perform the selected motion sequence, so as to fulfill the task.

11. The system as recited in claim 10, the memory further storing instructions that, when executed by the processor, further cause the autonomous system to:
perform the pose estimation so as to determine a pose associated with the goal state of the object.

12. The system as recited in claim 11, the memory further storing instructions that, when executed by the processor, further cause the autonomous system to:
determine the plurality of intermediate states based on the initial state, the pose associated with the goal state, and the task.

13. The system as recited in claim 12, the memory further storing instructions that, when executed by the processor, further cause the autonomous system to:
perform an affordance analysis on the object so as to determine a plurality of feasible actions for the autonomous machine in completing the task.

14. The system as recited in claim 14, the memory further storing instructions that, when executed by the processor, further cause the autonomous system to:
generate an affordance map associated with the object,
based on the affordance map, determine that the goal state of the object is not reachable without reaching at least one of the plurality of intermediate states.

15. The system as recited in claim 14, the memory further storing instructions that, when executed by the processor, further cause the autonomous system to:
based on the affordance map and task, generate at least one intermediate state of the plurality of intermediate states, the at least one additional intermediate state enabling the goal state to be reachable; and
augmenting the affordance map with the at least one additional intermediate state.

16. The system as recited in claim 10, the memory further storing instructions that, when executed by the processor, further cause the autonomous system to:
determine that the selected motion sequence defines a path that is shorter than the other motion sequences.

17. The system as recited in claim 14, the memory further storing instructions that, when executed by the processor, further cause the autonomous system to:
solve a Markov decision problem defined by the initial state, the goal state, and the plurality of the intermediate states.

18. The system as recited in claim 10, wherein the selected motion sequence defines a plurality of state transitions, and the memory further stores instructions that, when executed by the processor, further cause the autonomous system to:
execute a first state transition of the plurality of state transitions; and
before executing a second state transition of the plurality of state transitions that directly follows the first state transition, determine whether a first intermediate state associated with the first state transition is reached.
